(19) United States
(12) Patent Application Publication
(10) Pub. No.: US 2011/0182599 A1
(43) Pub. Date: Jul. 28, 2011

(54) IMAGE FORMING APPARATUS, ALIGNMENT CORRECTING METHOD, AND ALIGNMENT CORRECTING PROGRAM

(75) Inventor: Osamu Namura, Kanagawa-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 13/014,184

(22) Filed: Jan. 26, 2011

Related U.S. Application Data
(60) Provisional application No. 61/299,064, filed on Jan. 28, 2010.

(51) Int. Cl. G03G 15/01

(52) U.S. Cl. 399/39

(57) ABSTRACT

According to one embodiment, an image forming apparatus includes: a light emitting section; plural photoconductive members on which electrostatic latent images are respectively formed by emitted lights of the light emitting section; a developing section configured to develop, with toners of colors different from one another, the electrostatic latent images formed on the photoconductive members; a transfer section onto which images developed by the developing section are transferred; and a light-emission control section configured to control the light emitting section to thereby selectively form, on the transfer section, first test images respectively formed for the toners of the respective colors and printed at a first interval in a sub-scanning direction and second test images respectively formed for the toners of the respective colors and printed at a second interval smaller than the first interval in the sub-scanning direction.

### CROSS-REFERENCE TO RELATED APPLICATION

This application is also based upon and claims the benefit of priority from U.S. provisional application 61/299,064, filed on Jan. 28, 2010; the entire contents of which are incorporated herein by reference.

### FIELD

Embodiments described herein relate generally to a technique for performing alignment correction in an image forming apparatus.

### BACKGROUND

An image forming apparatus is known that prints test images on a transfer belt and performs alignment correction using the test images. The alignment correction includes parallel correction in a sub-scanning direction, correction of a writing start position in a main scanning direction, and correction concerning a magnification, a tilt, and the like. As a method of performing all of these kinds of alignment correction, a method of performing alignment correction using figures having a wedge shape is conceivable. The wedge shape includes a segment extending in the main scanning direction and a segment extending in a direction oblique to the main scanning direction. Therefore, the test images expand in the sub-scanning direction, it takes long time to perform the alignment correction, and scenes in which the alignment correction is performed are limited. Specifically, when the alignment correction is performed during a printing operation, the printing operation is suspended or the alignment correction cannot be performed until a printing job is completed.

### DESCRIPTION OF THE DRAWINGS

FIG. 1 is a sectional view of an internal configuration of a color digital multifunction peripheral;

FIG. 2 is a schematic block diagram of a configuration example of a control system in the digital multifunction peripheral;

FIG. 3 is a diagram of the arrangement of sections in a light scanning section;

FIG. 4 is a diagram of a configuration example of an optical system in the light scanning section;

FIG. 5 is a diagram for explaining scanning of a laser beam in the light scanning section;

FIG. 6 is a plan view of a transfer belt;

FIG. 7 is a plan view of the transfer belt on which first test images are printed;

FIG. 8 is a plan view of the transfer belt on which second test images are printed;

FIG. 9 is a plan view of the transfer belt in which a positional relation between transfer sheets and the second test images is shown;

FIG. 10 is a flowchart for explaining an alignment correcting method for performing alignment correction using the second test images; and

FIG. 11 is a plan view of the transfer belt in which a positional relation between the transfer sheets and the second test images is shown (another embodiment)

### DETAILED DESCRIPTION

In general, according to one embodiment, an image forming apparatus includes: a light emitting section; plural photoconductive members on which electrostatic latent images are respectively formed by emitted lights of the light emitting section; a developing section configured to develop, with toners of colors different from one another, the electrostatic latent images formed on the photoconductive members; a transfer section onto which images developed by the developing section are transferred; and a light-emission control section configured to control the light emitting section to thereby selectively form, on the transfer section, first test images respectively formed for the toners of the respective colors and printed at a first interval in a sub-scanning direction and second test images respectively formed for the toners of the respective colors and printed at a second interval smaller than the first interval in the sub-scanning direction.

According to another embodiment, an image forming apparatus includes: a light emitting section; plural photoconductive members on which electrostatic latent images are respectively formed by emitted lights of the light emitting section; a developing section configured to develop, with toners of colors different from one another, the electrostatic latent images formed on the photoconductive members; a transfer section onto which images developed by the developing section are transferred; a sheet feeding section configured to feed a transfer sheet to the transfer section; and a light-emission control section configured to control the light emitting section such that test images for performing alignment correction in a sub-scanning direction are formed among sheets continuously fed from the sheet feeding section to the transfer section, the test images being respectively formed for the toners of the respective colors and printed in the sub-scanning direction.

An image forming apparatus according to an embodiment is explained below with reference to the accompanying drawings.

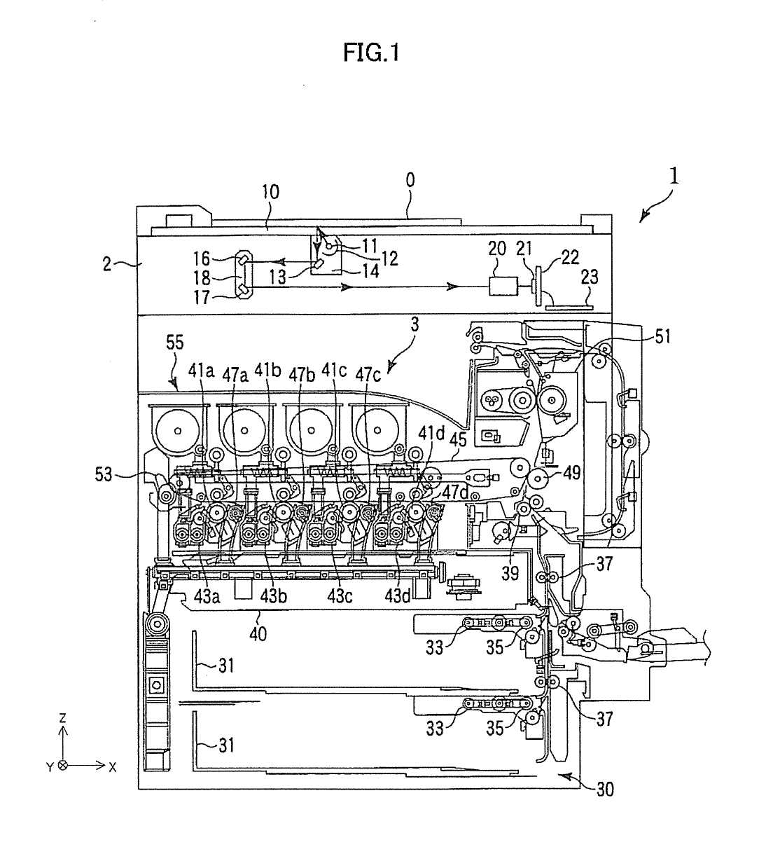

FIG. 1 is a sectional view of an internal configuration of a color digital multifunction peripheral 1 as an example of the image forming apparatus according to this embodiment.

The digital multifunction peripheral 1 shown in FIG. 1 includes a reading optical system 2 and an image forming section 3. The reading optical system 2 optically scans the surface of an original document to thereby read an image on the original document as color image data (multi-value image data). The image forming section 3 forms an image based on the color image data (the multi-value image data). The digital multifunction peripheral 1 includes, as means for inputting and outputting image data, a facsimile interface (not shown) for transmitting and receiving facsimile data or a network interface (not shown) for performing network communication. The digital multifunction peripheral 1 functions as a copy machine, a scanner, a printer, a facsimile machine, or a network communication machine.

First, the configuration of the reading optical system 2 is explained below. The reading optical system 2 includes, as shown in FIG. 1, a document table 10, a light source 11, a reflector 12, a first mirror 13, a first carriage 14, a second mirror 16, a third mirror 17, a second carriage 18, a condenser lens 20, a three-line CCD sensor 21, a CCD board 22, and a CCD control board 23.

An original document O is placed on the document table 10. The document table 10 may be, for example, glass. The light source 11 exposes the original document O placed on the document table 10 to light. The reflector 12 adjusts a light distribution of light from the light source 11. The first mirror 13 leads light received from the surface of the original document O to the second mirror 16. The first carriage 14 is mounted with the light source 11, the reflector 12, and the first mirror 13. The first carriage 14 moves at predetermined speed (V) in a sub-scanning direction of the surface of the original document O.

The second mirror 16 and the third mirror 17 lead light received from the first mirror 13 to the condenser lens 20. The second carriage 18 is mounted with the second mirror 16 and the third mirror 17. The second carriage 18 moves in the sub-scanning direction at half speed (V/2) of the speed (V) of the first carriage 14. The second carriage 18 moves following the first carriage 14 at the half speed of the speed of the first carriage 14 to thereby keep a distance from a reading position of the surface of the original document O to a light receiving surface of the three-line CCD sensor 21 at fixed optical path length.

The light from the surface of the original document O is made incident on the condenser lens 20 via the first, second, and third mirrors 13, 16, and 17. The condenser lens 20 leads the incident light to the three-line CCD sensor 21 configured to convert the incident light into an electric signal. Specifically, reflected light from the surface of the original document O is transmitted through glass of the document table 10, sequentially reflected by the first mirror 13, the second mirror 16, and the third mirror 17, and focused on the light receiving surface of the three-line CCD sensor 21 via the condenser lens 20.

The three-line CCD sensor 21 includes a line sensor in which photoelectric conversion elements for converting light into an electric signal are arranged in a main scanning direction. The three-line CCD sensor 21 converts light from the original document O into an electric signal including image signals of three colors that form a color image. For example, when the color image is read in the three primary colors of light including R (red), G (green), and B (blue), the three-line CCD sensor 21 includes an R line sensor 21R configured to read an image of R (red), a G line sensor 21G configured to read an image of G (green), and a B line sensor 21B configured to read an image of B (blue).

The CCD board 22 includes a sensor driving circuit (not shown) for driving the three-line CCD sensor 21. The CCD control board 23 controls the COD board 22 and the three-line CCD sensor 21. The COD control board 23 includes a control circuit (not shown) configured to control the CCD board 22 and the three-line CCD sensor 21 and an image processing circuit (not shown) configured to perform processing of an image signal output from the three-line CCD sensor 21.

The configuration of the image forming section 3 is explained below. The image forming section 3 includes, as shown in FIG. 1, a sheet feeding section 30, a light scanning section 40 functioning as a light emitting section, first to fourth photoconductive drums 41a to 41d functioning as plural photoconductive members, first to fourth developing devices 43a to 43d functioning as developing sections, a transfer belt 45 functioning as a transfer section, cleaners 47a to 47d, a transfer device 49, a fixing device 51, a belt cleaner 53, and a stock section 55.

The light scanning section 40 emits laser beams (exposure lights) for forming latent images on the first to fourth photoconductive drums 41a to 41d. It is assumed that the first to fourth photoconductive drums 41a to 41d respectively correspond to three colors (Y, M, and C) and black (K) that form a color image. The light scanning section 40 irradiates exposure lights corresponding to components of colors in image data on the photoconductive drums 41a to 41d functioning as image bearing members for the respective colors. Electrostatic latent images corresponding to the intensities of the laser beams (the exposure lights) irradiated from the light scanning section 40 are formed on the photoconductive drums 41a to 41d. The first to fourth photoconductive drums 41a to 41d hold the formed electrostatic latent images, which are images of the respective colors.

The first to fourth developing devices 43a to 43d respectively develop, with specific colors, the electrostatic latent images held by the photoconductive drums 41a to 41d. Specifically, the developing devices 43a to 43d supply toners of the respective colors to the electrostatic latent images held by the photoconductive drums 41a to 41d corresponding to the developing devices 43a to 43d to thereby develop images. For example, the image forming section 3 may obtain a color image by performing subtractive color mixing using three colors of yellow, magenta, and cyan. In this case, the first to fourth developing devices 43a to 43d respectively visualize (develop), with any of the colors of yellow, magenta, cyan, and black, the electrostatic latent images held by the photoconductive drums 41a to 41d. The first to fourth developing devices 43a to 43d respectively store toners of any of the colors of yellow, magenta, cyan, and black. The colors stored in the first to fourth developing devices 43a to 43d (order for developing the images of the respective colors) are determined according to an image forming process or characteristics of the toners. In this embodiment, it is assumed that the photoconductive drums 41a to 41d and the developing devices 43a to 43d respectively correspond to yellow (Y), magenta (M), cyan (C), and black (K).

The transfer belt 45 functions as an intermediate transfer member. Toner images of the respective colors formed on the photoconductive drums 41a to 41d are transferred in order onto the transfer belt 45 functioning as the intermediate transfer member. For example, the toner images on the photoconductive drums 41a to 41d carried to an intermediate transfer position are transferred onto the transfer belt 45 by an intermediate transfer voltage. Consequently, a color toner image obtained by superimposing the images of the four colors (yellow, magenta, cyan, and black) one on top of another is formed on the transfer belt 45. The transfer device 49 transfers the toner image formed on the transfer belt 45 onto a transfer sheet. A positional deviation sensor 26 is located on a downstream side in a conveying direction of the transfer belt 45 of the photoconductive drum 41d. Details of the positional deviation sensor 26 are explained later.

The sheet feeding section 30 feeds a sheet, onto which the toner image is transferred from the transfer belt 45 functioning as the intermediate transfer member, to the transfer device 49. The sheet feeding section 30 feeds the sheet to a transfer position of the toner image by the transfer device 49 at appropriate timing. The sheet feeding section 30 includes plural cassettes 31, plural pickup rollers 33, plural separating mechanisms 35, plural conveying rollers 37, and an aligning roller 39.

The plural cassettes 31 respectively store sheets, which are media on which images are formed. The cassettes 31 can store sheets of arbitrary sizes up to a predetermined number of sheets. Each of the pickup rollers 33 extracts the sheets from a designated cassette 31 one by one. For example, the cassette 31 directly instructed by a user is designated or the cassette 31 in which sheets of an optimum size calculated from a document size, a magnification, or the like are stored is designated.

Each of the separating mechanisms 35 prevents two or more sheets from being extracted from the cassette 31 by the pickup roller 33 (separates the sheets one by one). The plural conveying rollers 37 convey the one sheet separated by the separating mechanism 35 to the aligning roller 39. The aligning roller 39 conveys, according to timing when the transfer device 49 transfers the toner image from the transfer belt 45 (the toner image moves (in the transfer position)), the sheet to a transfer position where the transfer device 49 and the transfer belt 45 are in contact with each other.

The fixing device 51 fixes the toner image on the sheet. The fixing device 51 fixes the toner image on the sheet by, for example, heating the sheet in a pressed state. The fixing device 51 conveys the sheet subjected to fixing processing to the stock section 55. The stock section 55 is a paper discharging section configured to discharge a sheet subjected to image formation processing (on which an image is printed). In the configuration example shown in FIG. 1, the stock section 55 is located in a space between the reading optical system 2 and the image forming section 3.

The belt cleaner 53 cleans the transfer belt 45. The belt cleaner 53 is in contact with the transfer belt 45 in a predetermined position. The belt cleaner 53 removes, from the transfer belt 45, a waste toner remaining on a transfer surface on the transfer belt 45 onto which the toner image is transferred.

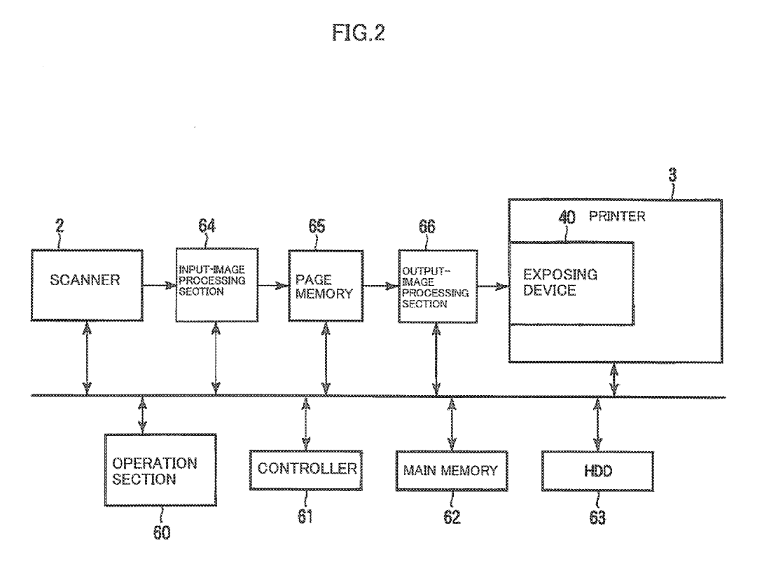

The configuration of a control system of the digital multifunction peripheral 1 is explained below. FIG. 2 is a schematic block diagram of a configuration example of the control system of the digital multifunction peripheral 1. As shown in FIG. 2, the digital multifunction peripheral 1 includes, besides the reading optical system 2 and the image forming section 3, an operation section 60, a controller 61, a main memory 62, a HDD 63, an input-image processing section 64, a page memory 65, and an output-image processing section 66 as components of the control system.

The user inputs an operation instruction to the operation section (a control panel) 60. Guidance for the user is displayed on the operation section 60. The operation section 60 includes a display device and an operation key. For example, the operation section 60 includes a liquid crystal display device incorporating a touch panel and hard keys such as a ten key.

The controller 61 collectively controls the entire digital multifunction peripheral 1. The controller 61 executes, for example, computer programs stored in a not-shown program memory to thereby realize various functions. The main memory 62 is a memory in which work data and the like are stored. The controller 61 executes various computer programs using the main memory 62 to thereby execute various kinds of processing. For example, the controller 61 controls the scanner 2 and the printer 3 according to a computer program for copy control to thereby realize the copy control. In other words, the controller 61 executes the computer program for copy control, whereby the digital multifunction peripheral 1 functions as a copy machine.

The HDD (hard disk drive) 63 is a nonvolatile large-capacity memory. For example, the HDD 63 stores therein image data. The HDD 63 stores therein setting values (default setting values) in various kinds of processing. The computer programs executed by the controller 61 may be stored in the HDD 63.

The input-image processing section 64 processes an input image. The input-image processing section 64 functions as, for example, an image processing section of a scanner system configured to process, as an input image, an image read by the scanner 2. In this case, the input-image processing section executes shading correction processing, gradation conversion processing, inter-line correction processing, magnification processing, and compression processing on image data read by the scanner 2.

For example, the shading correction processing is processing for correcting image data according to sensitivity fluctuation of photoelectric conversion elements in a CCD or a light distribution characteristic of a lamp (not shown) for illuminating an original document. The gradation conversion processing is processing for converting values of pixels that form the image data (e.g., signal values of R, G, and B) according to a not-shown lookup table (LUT). The inter-line correction processing is processing for correcting physical positional deviation of sensors for RGB in a CCD line sensor of the scanner 2. The magnification processing is processing for reducing or expanding the image data to desired size through image processing. The compression processing is processing for quantizing the image data in order to compress a data amount. Code data as the image data subjected to the compression processing (the quantized image data) is stored in the page memory 65.

The page memory 65 is a memory configured to store image data set as a processing target. For example, the page memory 65 stores color image data for one page. The page memory 65 is controlled by a not-shown page-memory control section. In the configuration example shown in FIG. 2, the page memory 65 stores image data that is a processing result of the input image processed by the input-image processing section 64.

The output-image processing section 66 processes an output image. In the configuration example shown in FIG. 2, the output-image processing section 66 functions as an image processing section of a printer system configured to generate image data to be printed on a sheet by the printer 3. The output-image processing section 66 converts the image data stored in the page memory 65 into image data for a printer.

For example, the output-image processing section 66 applies processing such as expansion processing, pixel conversion processing, filter processing, inking processing, gamma correction, and gradation processing to the image data read out from the page memory 65. The expansion processing is processing for expanding the quantized (encoded) data (compressed image data) stored in the page memory 65. The pixel conversion processing is processing for converting a color image formed of R, G, and B signals read out from the page memory 65 into color image data for print formed by Y, N, C, K (black) signals. The filter processing is processing for correcting image data according to a type of an image. The inking processing is processing for detecting an area of a black character or the like to be printed in a black (K) single color in the image data. The gamma correction processing is processing for correcting the image data according to a gamma characteristic of the printer 3. The gradation processing is processing for applying screen processing to the image data subjected to the gamma correction.

The output-image processing section 66 is connected to the light scanning section 40 in the printer 3. The controller 61 performs control of the light scanning section 40. The controller 61 controls, on the basis of image signals of the respective colors output from the output-image processing section 66, laser beams irradiated on the photoconductive drums 41a, 41b, 41c, and 41d for the respective colors. A laser beam unit 70 emits the laser beams according to the control by the controller 61.

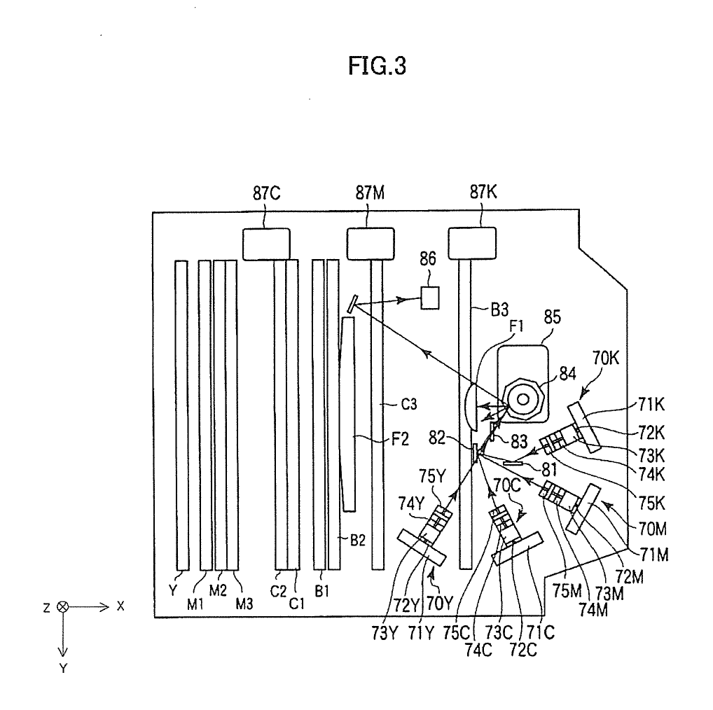

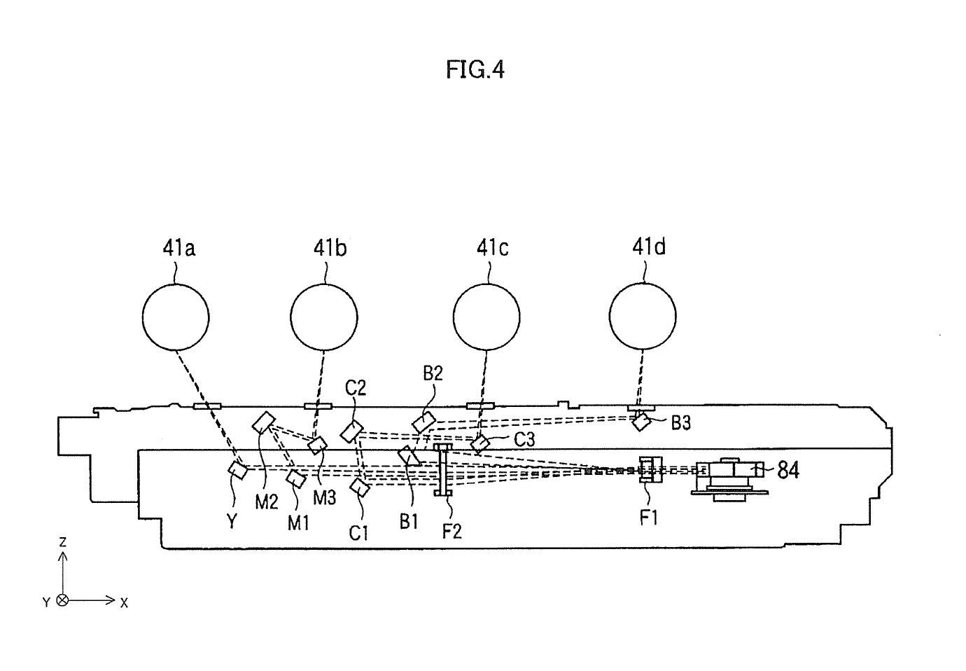

The configuration of the light scanning section 40 is explained below. FIGS. 3 and 4 are diagrams of a configuration example of the light scanning section 40. The arrangement of sections in the light scanning section 40 is shown in FIG. 3. A configuration example of an optical system in the light scanning section 40 is shown in FIG. 4. The light scanning section 40 includes, as shown in FIG. 3, the laser beam units 70 (70Y, 70M, 70C, and 70K), three pre-deflection mirrors 81, 82, and 83, a polygon mirror 84, a polygon motor 85, two fθ lenses F1 and F2, a BD sensor 86, three mirror motors 87 (87M, 87C, and 87K), and plural mirror groups Y, M1 to M3, C1 to C3, and K1 to K3.

The laser beam units 70 (70Y, 70M, 70C, and 70K) respectively include laser driving boards 71 (71Y, 71M, 71C, and 71K), laser diode (LD) arrays 72 (72Y, 72M, 72C, and 72K), finite focus lenses 73 (73Y, 73M, 73C, and 73K), apertures 74 (74Y, 74M, 74C, and 74K), and cylinder lenses 75 (75Y, 75M, 75C, and 75K). The laser beam units 70 are equivalent to light emitting sections.

In each of the laser beam units 70, the laser driving board 71 is connected to the controller 61. The laser driving board 71 outputs, on the basis of an image signal from the output-image processing section 66, a driving signal for emitting a laser beam. The laser driving board 71 causes the light emitting section in the laser diode (LD) array 72 to emit a laser beam according to the driving signal. In each of the laser beam units 70, the laser diode (LD) array 72 emits a laser beam on the basis of the driving signal output by the laser driving board 71 according to the image data output from the output-image processing section 66. In the light scanning section 40, the LD array 72 is a laser diode of a multi-beam array type that can emit plural laser beams. In this embodiment, the LD array 72 is a laser diode of a four-beam array type that can emit four laser beams.

Each of the laser beam units 70 emits laser beams, which are emitted from the LD array 72, via the finite focus lens 73, the aperture 74, and the cylinder lens 75. Each of the laser beam units 70 is set to irradiate the emitted laser beams on any of the pre-deflection mirrors 81 and 82 to make the laser beams incident on the polygon mirror 84 or directly irradiate the laser beams on the polygon mirror 84.

For example, the laser beam unit 70K is set to irradiate a laser beam for forming a black image (a laser beam for black), which is reflected by the pre-deflection mirror 81 and the pre-deflection mirror 82, on the polygon mirror 84 via the pre-deflection mirror 83. The laser beam unit 70M is set to irradiate a laser beam for forming a magenta image (a laser beam for magenta), which is reflected by the pre-deflection mirror 82, on the polygon mirror 84 via the pre-deflection mirror 83. The laser beam unit 70C is set to irradiate a laser beam for forming a cyan image (a laser beam for cyan), which is reflected by the pre-deflection mirror 82, on the polygon mirror 84 via the pre-deflection mirror 83. The laser beam unit 70Y is set to directly irradiate a laser beam for forming a yellow image (a laser beam for yellow) on the polygon mirror 84 via the pre-deflection mirror 83.

The polygon mirror 84 includes a mirror having multiple surfaces (eight surfaces) and is rotated by the polygon motor 85. The laser beams for the respective colors irradiated on the polygon mirror 84 are respectively scanned in the main scanning direction by the mirror surfaces of the polygon mirror 84. In the light scanning section 40, the optical system is formed to lead the laser beams for the respective colors, which are scanned in the main scanning direction by the polygon mirror 84, to photoconductive drum surfaces for the respective colors.

For example, the laser beam for black passed through the two fθ lenses F1 and F2 is sequentially reflected by three mirrors for black B1, B2, and B3 and irradiated on the photoconductive drum 41d. In other words, as shown in FIG. 4, the mirrors for black E1, B2, and B3 are set to lead the laser beam for black, which is scanned in the main scanning direction by the polygon mirror 84, to the photoconductive drum 41d. The mirrors for black B1, B2, and B3 are configured to be adjusted by the mirror motor 87K.

The laser beam for magenta passed through the two f θ lenses F1 and F2 is sequentially reflected by three mirrors for magenta M1, M2, and M3 and irradiated on the photoconductive drum 41b. In other words, as shown in FIG. 4, the mirrors for magenta M1, M2, and M3 are set to lead the laser beam for magenta, which is scanned in the main scanning direction by the polygon mirror 84, to the photoconductive drum 41b. The mirrors for magenta M1, M2, and M3 are configured to be adjusted by the mirror motor 87M.

The laser beam for cyan passed through the two fθ lenses F1 and F2 is sequentially reflected by three mirrors for cyan C1, C2, and C3 and irradiated on the photoconductive drum 41c. In other words, as shown in FIG. 4, the mirrors for cyan C1, C2, and C3 are set to lead the laser beam for cyan, which is scanned in the main scanning direction by the polygon mirror 84, to the photoconductive drum 41c. The positions of the mirrors for cyan C1, C2, and C3 are adjusted by driving the mirror motor 87C.

The laser beam for yellow passed through the two fθ lenses F1 and F2 is sequentially reflected by one mirror for yellow Y and irradiated on the photoconductive drum 41a. In other words, as shown in FIG. 4, the mirror for yellow Y is set to lead the laser beam for yellow, which is scanned in the main scanning direction by the polygon mirror 84, to the photoconductive drum 41a. It is assumed that a setting position of the mirror for yellow Y is fixed.

As explained above, the laser beams emitted from the laser beam units are reflected by the plural mirrors until the laser beams reach the photoconductive drums 41. The configuration of the optical system for leading the laser beams to the photoconductive drums 41 depends on the configurations of the sections in the image forming apparatus. For example, in the image forming apparatus, setting conditions for the light scanning section 40 (e.g., an area where the light scanning section 40 can be set) are considered to be different for each model of image forming apparatuses. The number of set mirrors, setting positions of the mirrors, and the like in the light scanning section 40 can also be changed according to the configuration of the LD array itself.

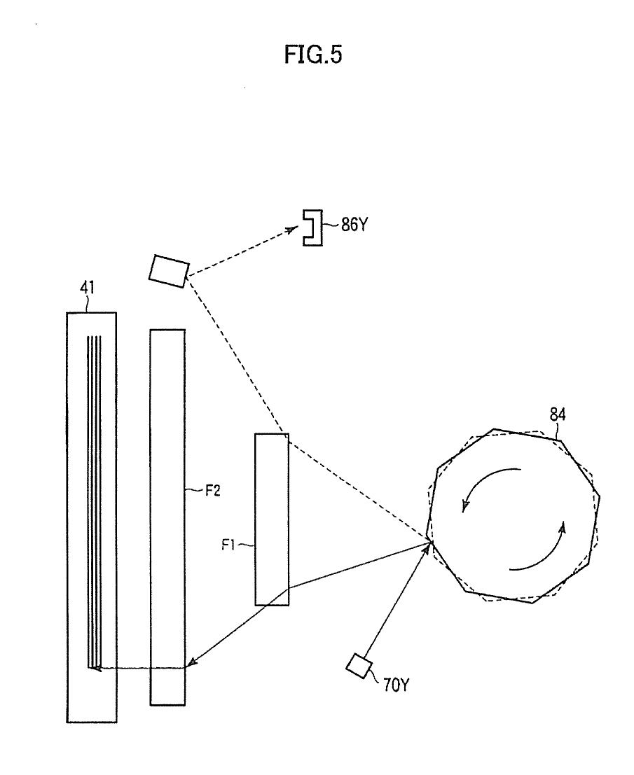

Scanning of a laser beam in the light scanning section 40 is explained below. FIG. 5 is a diagram for explaining the scanning of the laser beam in the light scanning section 40. In FIG. 5, a scanning path of a laser beam for yellow is schematically shown. In FIG. 5, the laser beam unit for cyan 70C, the laser beam unit for black 70K, the pre-deflection mirrors 81, 82, and 83, the mirrors for the respective colors Y, M1 to M3, C1 to C3, and K1 to K3, and the like are not shown.

As shown in FIG. 5, in the light scanning section 40, a laser beam emitted from each of the laser beam units 70 is reflected by the polygon mirror 84 and irradiated on each of the photoconductive drums 41 via the fθ lenses F1 and F2 or the like. As explained above, the polygon mirror 84 rotated by the polygon motor 85 scans the laser beam once in the main scanning direction with a mirror of one surface. Consequently, an electrostatic latent image is formed on the photoconductive drum 41 by the laser beam scanned in the main scanning direction. The laser beam scanned in the main scanning direction on the photoconductive drum 41 is scanned at a desired interval in the sub-scanning direction. For example, an interval of plural light emitting elements in the LD array 72 of each of the laser beam units 70 explained later is designed to correspond to the interval in the sub-scanning direction.

The BD sensor 86 is set to detect a BD signal (also referred to as HSYNC signal) every time the laser beam is scanned once in the main scanning direction. A plurality of the BD sensors 86 may be provided for the respective colors. The BD sensor 86 may be set to detect only a laser beam corresponding to a predetermined color (e.g., yellow or black). In FIG. 5, a configuration example in which the BD sensor 86 configured to detect a laser beam for a specific color is provided is shown. In the configuration example shown in FIG. 5, a BD mirror for leading a desired laser beam to the BD sensor 86 is set. The BD mirror is set to lead a desired laser beam, which passes on an upstream side in the main scanning direction in the second fθ lens F2, to the BD sensor 86. With such a configuration, in the light scanning section 40, timing for starting scanning of the laser beam in the main scanning direction can be achieved on the basis of the BD signal detected by the BD sensor 86.

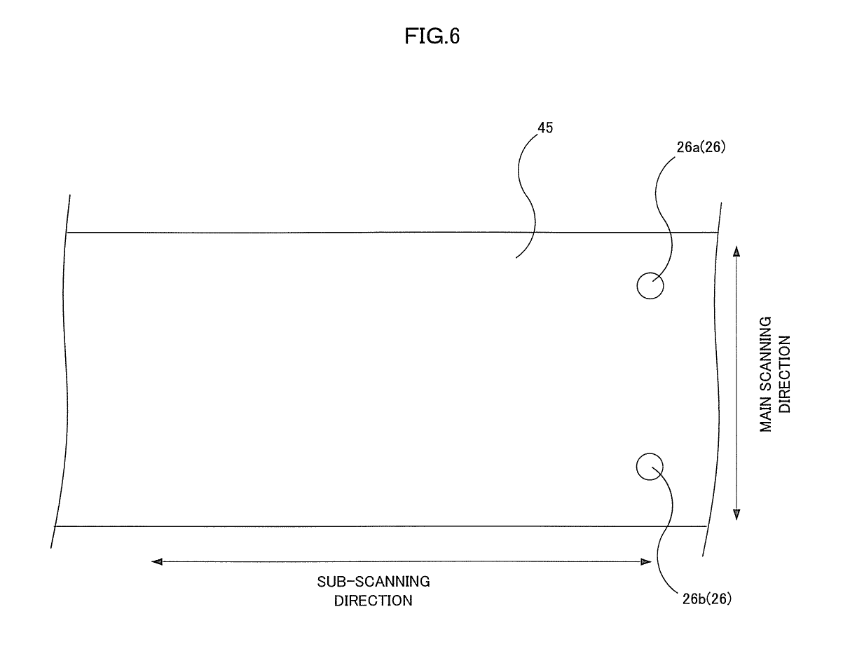

The positional deviation sensor 26 is explained below with reference to FIG. 6. FIG. 6 is a plan view of the transfer belt 45. The positional deviation sensor 26 includes a rear-side positional deviation sensor 26a and a front-side positional deviation sensor 26b configured to respectively detect test images formed at both ends in the main scanning direction of the transfer belt 45. The rear-side positional deviation sensor 26a detects a test image formed at one end side in the main scanning direction of the transfer belt 45. The front-side positional deviation sensor 26b detects a test image formed at the other end in the main scanning direction of the transfer belt 45.

The controller 61 performs alignment correction control on the basis of detection results of the rear-side positional deviation sensor 26a and the front-side positional deviation sensor 26b. The alignment correction control includes first alignment correction control for performing alignment correction for a main scanning direction, a sub-scanning direction, a tilt, and a magnification and second alignment correction control for performing only alignment correction for the sub-scanning direction.

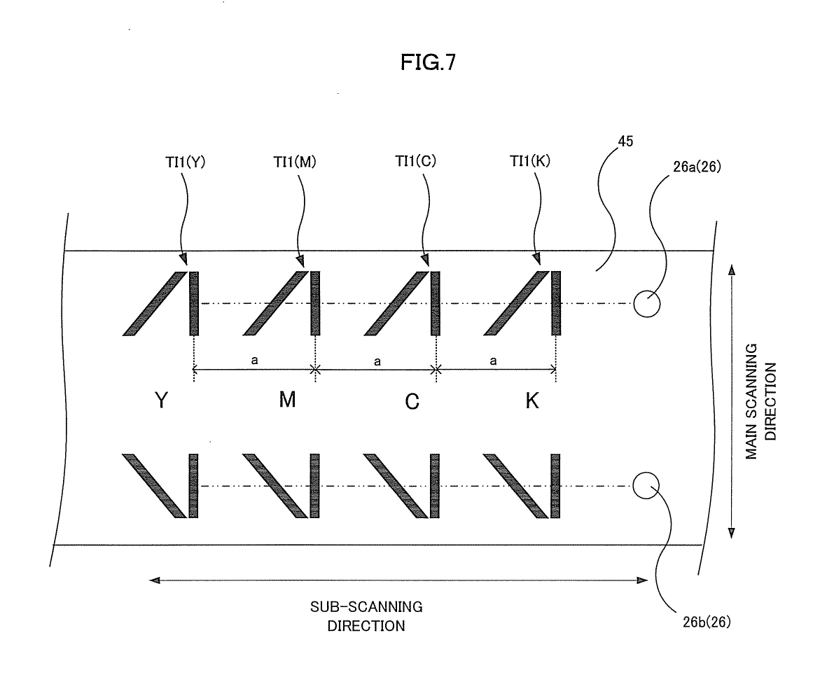

The first alignment correction control is explained in detail below with reference to FIG. 7. FIG. 7 is a plan view of the transfer belt. First test images used for the first alignment correction control are shown in FIG. 7.

As first test images TI1, plural wedge-shaped figures respectively formed by using yellow (Y), magenta (M), cyan (C), and black (K) are arrayed in the sub-scanning direction. Each of the wedge-shaped figures includes a segment extending in the main scanning direction and a segment extending in a direction oblique to the main scanning direction. The controller 61 calculates, on the basis of the first test images TI1 formed on the transfer belt 45, sub-scanning direction parallel deviation, main scanning direction writing start position deviation, a magnification, and a tilt and executes the alignment correction control.

The alignment correction for the sub-scanning direction may be performed by changing rotating speed of the transfer belt 45. The alignment correction for the main scanning direction writing start position may be performed by changing a laser writing start position.

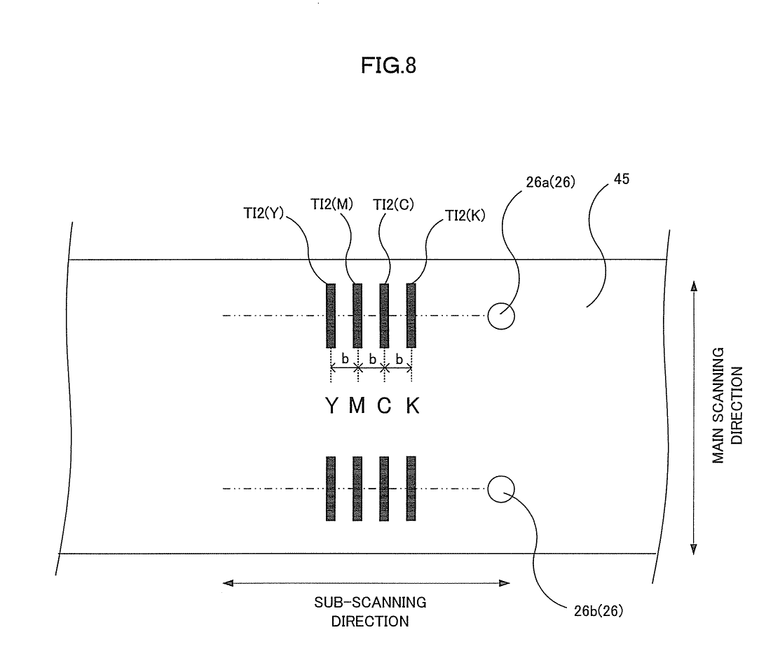

The second alignment correction control is explained in detail below with reference to FIG. 8. FIG. 8 is a plan view of the transfer belt. Second test images used for the second alignment correction control are shown in FIG. 8.

As second test images TI2, linear figures extending in the main scanning direction respectively formed by using yellow (Y), magenta (M), cyan (C), and black (K) are arrayed in the sub-scanning direction. The controller 61 calculates sub-scanning direction parallel deviation on the basis of the second test images TI2 formed on the transfer belt 45 and performs the alignment correction control.

When the temperature of the fixing device 51 rises to fixing temperature, the digital multifunction peripheral 1 performs the first alignment correction control. In other words, the digital multifunction peripheral 1 performs the first alignment correction control in a temperature rising stage of the fixing device 51 that stops a printing operation. The temperature rising stage may be during a temperature raising operation in which a power supply for the digital multifunction peripheral 1 is switched from OFF to ON and the temperature of the fixing device 51 rises to the fixing temperature. The temperature rising stage may be during a temperature raising operation in which the digital multifunction peripheral 1 returns from a power saving state to a use state and the temperature of the fixing device 51 rises to the fixing temperature.

Referring to FIGS. 7 and 8, when an interval of the first test images adjacent to each other in the sub-scanning direction is represented as interval “a” and an interval of the second test images TI2 adjacent to each other in the sub-scanning direction is represented as interval “b”, the interval “a” is larger than the interval “b”.

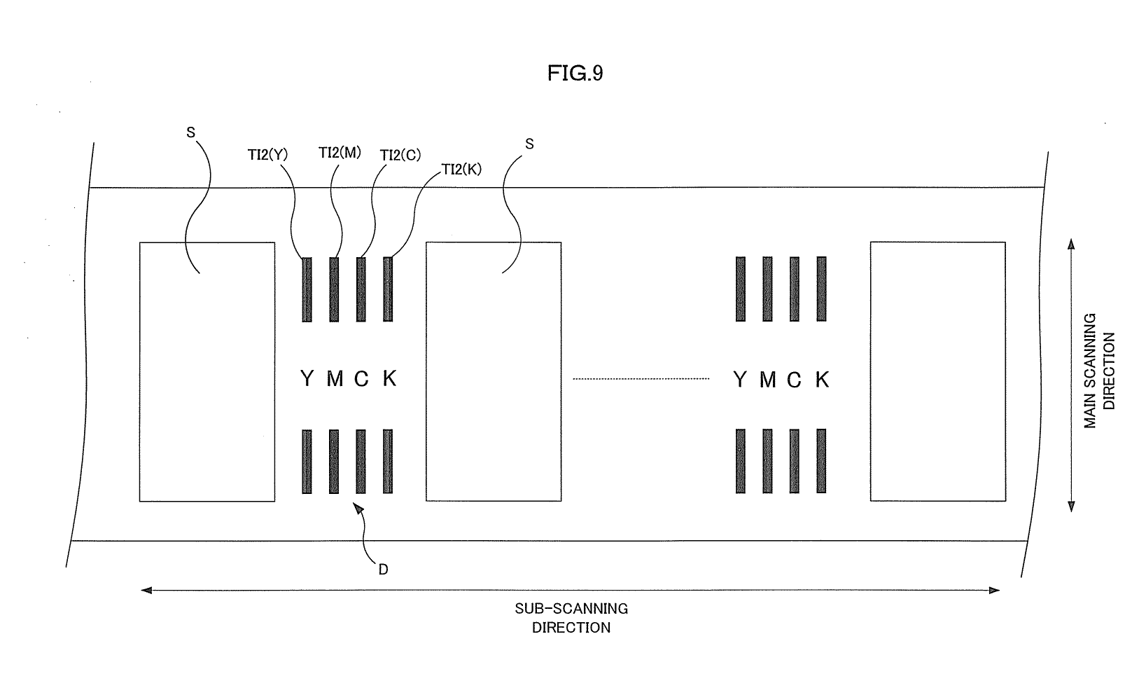

FIG. 9 is a plan view of the transfer belt 45. A positional relation between the second test images TI2 printed on the transfer belt 45 and transfer sheets S is shown in FIG. 9. The second test images TI2 are located in open areas D formed among the transfer sheets S continuously fed to the transfer belt 45. During the printing operation, since the transfer sheets S are continuously fed to the transfer belt 45, an interval in the sub-scanning direction of the open areas D is narrow.

During the printing operation of the digital multifunction peripheral 1, when the first alignment correction control is performed, since the interval “a” of the first test images TI1 is large, it is necessary to suspend the printing operation. If the first alignment correction control is performed without stopping the printing operation, the first test images TI1 do not fit in the open areas D on the transfer belt 45. Therefore, the first test images TI1 are printed across the transfer belt 45 and the transfer sheets S. Because of these reasons, the first alignment correction control is performed during the temperature raising operation in which the printing operation is not performed.

On the other hand, since the interval “b” of the second test images TI2 is set smaller than the interval “a” of the first test images TI1, even if the second alignment correction control is performed during the printing operation, the second test images TI2 are not printed on the transfer sheets S. Since positional deviation in the main scanning direction or the like has a deviation amount smaller than that of positional deviation in the sub-scanning direction or the like, a frequency of performing the alignment correction control may be small. Conversely, since the positional deviation in the sub-scanning direction has a deviation amount larger than of the positional deviation in the main scanning direction or the like, it is necessary to increase the frequency of performing the alignment correction control. Because of these reasons, the second alignment correction control for performing the alignment correction for only the sub-scanning direction may be performed during the printing operation.

The interval “a” of the first test images TI1 and the interval “b” of the second test images TI2 desirably satisfy a size relation a>3b. If the size relation a>3b is satisfied, the second test images TI2 are more surely printed in the open area D formed between the transfer sheet S adjacent to each other.

The HDD 63 stores therein a computer program for executing the first alignment correction control and the second alignment correction control. The controller 61 decodes the computer program and executes the computer program to perform the alignment correction control for the digital multifunction peripheral 1.

The controller 61 selectively performs the first alignment correction control and the second alignment correction control on the basis of the timing explained above to thereby reduce time required for the alignment correction control while appropriately performing the alignment correction control. It is unnecessary to stop, every time the alignment correction control is performed, the printing operation once started.

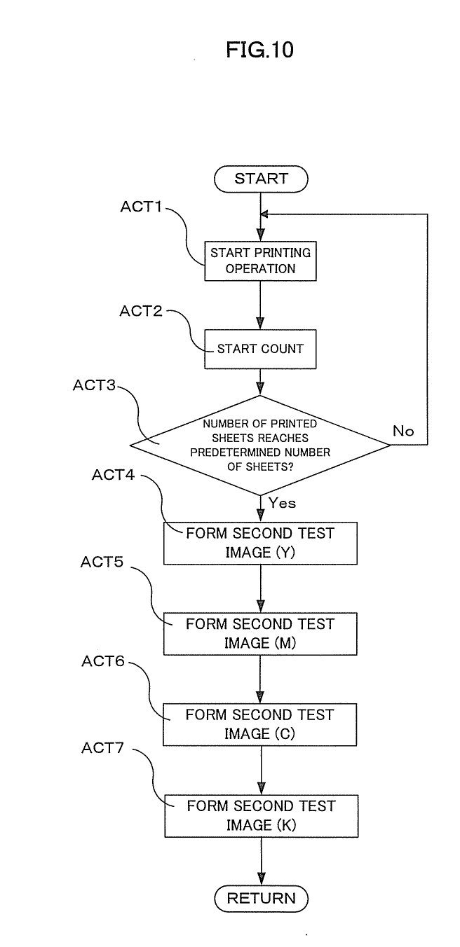

The alignment correction control performed using the first test images TI1 and the second test images TI2 are specifically explained below. FIG. 10 is a flowchart for explaining an example of the alignment correction control according to this embodiment. When the digital multifunction peripheral 1 starts the printing operation in ACT 1, the controller 61 proceeds to ACT 2. In ACT 2, the controller 61 starts detection of the number of printed sheets. The controller 61 may detect the number of times of pickup by the pickup rollers 33 to thereby count the number of printed sheets. The controller 61 may count the number of printed sheets from the number of times image formation is performed on transfer sheets. The controller 61 may store the counted number of printed sheets in the HDD 63.

In ACT 3, the controller 61 determines whether the number of printed sheets reaches a threshold. In this embodiment, since the second alignment correction control is performed without stopping the printing operation, a lower limit value of the threshold may be arbitrarily set. An upper limit value of the threshold may be set from the viewpoint of appropriately performing the alignment correction control for the sub-scanning direction. For example, the threshold may be five hundred.

In ACT 4, the controller 61 starts the second alignment correction control. Specifically, the controller 61 drives the LD array 72Y to thereby form an electrostatic latent image corresponding to a second test image (TI2(Y)) formed of yellow (Y) on the first photoconductive drum 41a. The controller 61 drives the LD array 72M to thereby form an electrostatic latent image corresponding to a second test image (TI2(M)) formed of magenta (M) on the second photoconductive drum 41b. The controller 61 drives the LD array 72C to thereby form an electrostatic latent image corresponding to a second test image (TI2(C)) formed of cyan (C) on the third photoconductive drum 41c. The controller 61 drives the LD array 72K to thereby form an electrostatic latent image corresponding to a second test image (TI2(K)) formed of black (K) on the fourth photoconductive drum 41d.

When these second test images TI2 are transferred onto the transfer belt 45, the controller 61 executes the alignment correction in the sub-scanning direction on the basis of a detection result of the positional deviation sensor 26.

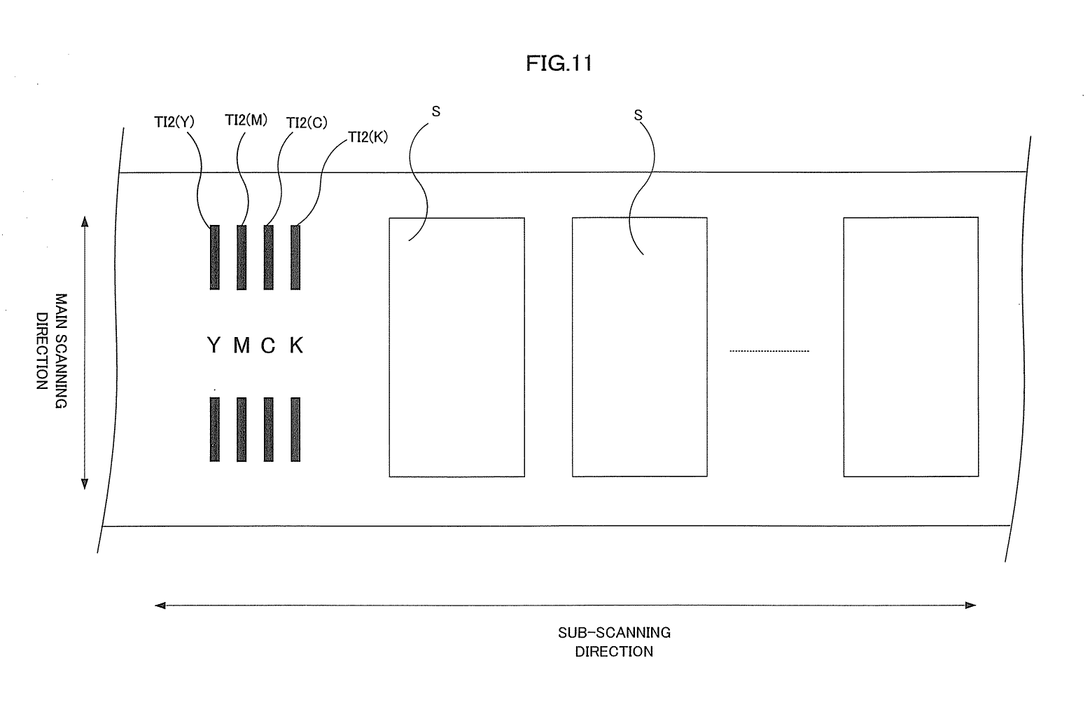

In this embodiment, the second test images TI2 are printed between the transfer sheets S adjacent to each other. However, as shown in FIG. 11, the second test images TI2 may be printed ahead of the transfer sheet S fed to the transfer belt 45 first after the start of printing.

In the example explained above, the computer program for causing the controller 61 to execute the processing according to this embodiment is recorded in advance in a storage area provided in the color digital multifunction peripheral 1. However, the computer program may be downloaded from a network to the color digital multifunction peripheral 1. The computer program stored in a computer-readable recording medium may be installed in the color digital multifunction peripheral 1. The recording medium only has to be a recording medium that can store the computer program and can be read by a computer. Examples of the recording medium include an internal storage device internally mounted in the computer such as a ROM or a RAM, a portable recording medium such as a CD-ROM, a flexible disk, a DVD disk, a magneto-optical disk, or an IC card, a database that stores a computer program, other computers and databases of the computers, and a transmission medium on a line. Functions obtained by the installation and the download may cooperate with an OS (operating system) or the like in the apparatus to cause the OS to realize the functions. It is also possible to cause an ASIC to execute, in terms of a circuit, at least a part of processing realized by causing a CPU or an MPU to execute the computer program.

The invention can be carried out in other various forms without departing from the spirit or the main characteristics thereof. Therefore, the embodiment is only an illustration in every aspect and should not be limitedly interpreted. The scope of the invention is indicated by the scope of claims and is by no means limited by the text of the specification. Further, all modifications, various improvements, substitutions, and alterations belonging to the scope of equivalents of the scope of claims are within the scope of the invention.

What is claimed is:

1. An image forming apparatus comprising:
a light emitting section;
plural photoconductive members on which electrostatic latent images are respectively formed by emitted lights of the light emitting section;
a developing section configured to develop, with toners of colors different from one another, the electrostatic latent images formed on the photoconductive members;
a transfer section onto which images developed by the developing section are transferred; and
a light-emission control section configured to control the light emitting section to thereby selectively form, on the transfer section, first test images respectively formed for the toners of the respective colors and printed at a first interval in a sub-scanning direction and second test images respectively formed for the toners of the respective colors and printed at a second interval smaller than the first interval in the sub-scanning direction.

2. The apparatus according to claim 1, further comprising a sheet feeding section configured to feed a transfer sheet to the transfer section, wherein
the light-emission control section controls the light emitting section to thereby form the second test images between sheets continuously fed from the sheet feeding section.

3. The apparatus according to claim 2, wherein, when the first interval is represented as “a” and the second interval is represented as “b”, Formula (1) below is satisfied.
a>3b (1)

4. The apparatus according to claim 1, wherein the second test images are formed in a linear shape extending in a main scanning direction.

5. The apparatus according to claim 1, further comprising:
a sheet feeding section configured to feed a transfer sheet to the transfer section; and
a fixing section configured to fix, on the transfer sheet fed from the sheet feeding section, an image transferred onto the transfer sheet, wherein
the light-emission control section controls the light emitting section such that the first test images are transferred onto the transfer section during a temperature raising operation in which temperature of the fixing section rises to fixing temperature.

6. The apparatus according to claim 5, wherein the light-emission control section controls the light emitting section such that the first test images are transferred onto the transfer section during a temperature raising operation in which the apparatus is switched from power-off to power-on and the temperature of the fixing section rises to the fixing temperature.

7. The apparatus according to claim 5, wherein the light-emission control section controls the light emitting section such that the first test images are transferred onto the transfer section during a temperature raising operation in which the apparatus returns from a power saving state to a use state and the temperature of the fixing section rises to the fixing temperature.

8. The apparatus according to claim 1, wherein the transfer section is a primary transfer belt that endlessly turns.

9. The apparatus according to claim 1, further comprising an alignment-correction control section configured to perform alignment correction control for a main scanning direction, a sub-scanning direction, a tilt, and a magnification on the basis of the first test images.

10. The apparatus according to claim 1, further comprising an alignment-correction control section configured to perform alignment correction control for only a sub-scanning direction on the basis of the second test images.

11. An image forming apparatus comprising:
a light emitting section;
plural photoconductive members on which electrostatic latent images are respectively formed by emitted lights of the light emitting section;
a developing section configured to develop, with toners of colors different from one another, the electrostatic latent images formed on the photoconductive members;
a transfer section onto which images developed by the developing section are transferred;
a sheet feeding section configured to feed a transfer sheet to the transfer section; and
a light-emission control section configured to control the light emitting section such that test images for performing alignment correction in a sub-scanning direction are formed among sheets continuously fed from the sheet feeding section to the transfer section, the test images being respectively formed for the toners of the respective colors and printed in the sub-scanning direction.

12. The apparatus according to claim 11, wherein the test images are formed in a linear shape extending in a main scanning direction.

13. The apparatus according to claim 11, wherein the transfer section is a primary transfer belt that endlessly turns.

14. An alignment correcting method comprising:
a computer arraying, during a temperature raising operation in which temperature of a fixing device of an image forming apparatus rises to fixing temperature, first test images formed of toners of colors different from one another at a first interval in a sub-scanning direction in a transfer section of the image forming apparatus and performing first alignment correction on the basis of the first test images; and
the computer arraying, during a printing operation of the image forming apparatus, second test images formed of toners of colors different from one another at a second interval smaller than the first interval in the sub-scanning direction in the transfer section and performing second alignment correction on the basis of the second test images.

15. The method according to claim 14, wherein the second test images are formed among transfer sheets continuously fed to the transfer section.

16. The method according to claim 15, wherein, when the first interval is represented as “a” and the second interval is represented as “b”, Formula (1) below is satisfied.
a>3b (1)

17. The method according to claim 14, wherein the second test images are formed in a linear shape extending in a main scanning direction.

18. An alignment correcting program for causing a computer to execute processing for:
arraying, during a temperature raising operation in which temperature of a fixing device of an image forming apparatus rises to fixing temperature, first test images formed of toners of colors different from one another at a first interval in a sub-scanning direction in a transfer section of the image forming apparatus and performing first alignment correction on the basis of the first test images; and
arraying, during a printing operation of the image forming apparatus, second test images formed of toners of colors different from one another at a second interval smaller than the first interval in the sub-scanning direction and performing second alignment correction on the basis of the second test images.

19. The program according to claim 18, wherein the second test images are formed among transfer sheets continuously fed to the transfer section.

20. The program according to claim 19, wherein, when the first interval is represented as “a” and the second interval is represented as “b”, Formula (1) below is satisfied.
a>3b (1)

21. The program according to claim 18, wherein the second test images are formed in a linear shape extending in a main scanning direction.
